(19) United States
(12) Patent Application Publication
(10) Pub. No.: US 2012/0309885 A1
(43) Pub. Date: Dec. 6, 2012

(54) SILICONE RESIN COMPOSITION AND THERMAL CONDUCTIVE SHEET

(75) Inventor: Keisuke HIRANO, Osaka (JP)

(73) Assignee: NITTO DENKO CORPORATION, Osaka (JP)

(21) Appl. No.: 13/488,784

(22) Filed: Jun. 5, 2012

(30) Foreign Application Priority Data
Jun. 6, 2011 (JP) 2011-126201
Jun. 6, 2011 (JP) 2011-126202

(51) Int. Cl. C08L 83/06; C08K 3/28; C08K 3/38

(52) U.S. Cl. 524/404; 524/428

(57) ABSTRACT

A silicone resin composition contains a borosiloxane resin containing a B—O—Si bond and boron nitride. A silicone resin composition contains an aluminosiloxane resin containing an Al—O—Si bond and aluminum nitride.

### CROSS-REFERENCE TO RELATED APPLICATION

The present application claims priority from Japanese Patent Applications No. 2011-126202 and No. 2011-126201 filed on Jun. 6, 2011, the contents of which are hereby incorporated by reference into this application.

### BACKGROUND OF THE INVENTION

1. Field of the Invention

The present invention relates to a silicone resin composition and a thermal conductive sheet, to be specific, to a silicone resin composition preferable for a heat dissipating material and a thermal conductive sheet prepared from the silicone resin composition.

2. Description of Related Art

Conventionally, a thermal conductive resin composition, which is interposed between a heating element such as an electronic component and a heat sink and transmits heat from the heating element to the heat sink, has been known. The thermal conductive resin composition is required to have an excellent flexibility in view of adhesiveness between the heating element and the heat sink.

As such a thermal conductive resin composition having an excellent flexibility, for example, a thermal conductive composition containing a straight chain highly polymerized silicone, organic solvent-soluble silicone resin, and boron nitride or aluminum nitride has been proposed (ref: for example, Japanese Unexamined Patent Publication No. H09-302231).

### SUMMARY OF THE INVENTION

However, in the above-described thermal conductive composition described in Japanese Unexamined Patent Publication No. H09-302231, thermal conductivity may be insufficient.

On the other hand, when the proportion of the boron nitride content or the aluminum nitride content is increased, there may be a case where the flexibility of the thermal conductive composition is reduced, while the thermal conductivity thereof can be improved.

It is an object of the present invention to provide a silicone resin composition capable of improving flexibility and thermal conductivity and a thermal conductive sheet prepared from the silicone resin composition.

A silicone resin composition of the present invention contains a borosiloxane resin containing a B—O—Si bond and boron nitride.

In the present invention of the silicone resin composition, it is preferable that the borosiloxane resin is prepared from a material component containing a condensation reaction type silicone resin and a boron atom complex, wherein the content ratio of the boron atom complex is 0.5 to 10 parts by mass with respect to 100 parts by mass of the material component.

In the present invention of the silicone resin composition, it is preferable that the condensation reaction type silicone resin contains an alkoxysilyl group-containing polysiloxane having basic constituent units of D unit and T unit, and an alkoxysilyl group-containing polysilsesquioxane having a basic constituent unit of T unit.

In the present invention of the silicone resin composition, it is preferable that the boron atom complex is trialkoxy boron.

In the present invention of the silicone resin composition, it is preferable that the borosiloxane resin is obtained by allowing the condensation reaction type silicone resin to react with the boron atom complex in a solvent containing water.

In the present invention of the silicone resin composition, it is preferable that reactive functional group-containing inorganic oxide particles are further contained.

In the present invention of the silicone resin composition, it is preferable that the reactive functional group-containing inorganic oxide particles are colloidal silica.

In the present invention of the silicone resin composition, it is preferable that the borosiloxane resin is obtained by allowing the condensation reaction type silicone resin to react with the boron atom complex in a mixed solvent which is prepared from water and an alcohol and contains the reactive functional group-containing inorganic oxide particles.

A method for producing a silicone resin composition of the present invention includes the steps of preliminarily preparing a material component by blending a condensation reaction type silicone resin with a boron atom complex; preparing a borosiloxane resin by allowing the material component to be reacted; and blending the borosiloxane resin with boron nitride.

In the producing method of the silicone resin composition of the present invention, it is preferable that in the preliminarily preparing step, the reactive functional group-containing inorganic oxide particles are further blended.

A thermal conductive sheet of the present invention is a thermal conductive sheet formed by allowing a silicone resin composition to be applied, wherein the silicone resin composition contains a borosiloxane resin containing a B—O—Si bond and boron nitride.

In the silicone resin composition of the present invention, the borosiloxane resin and the boron nitride are contained.

Therefore, a boron atom is contained in both of the borosiloxane resin and the boron nitride, so that the dispersibility of the boron nitride in the borosiloxane resin is improved and the thermal conductivity of the silicone resin composition can be improved. That is, the thermal conductivity of the silicone resin composition can be improved without increasing the proportion of the boron nitride content.

A silicone resin composition of the present invention contains an aluminosiloxane resin containing an Al—O—Si bond and aluminum nitride.

In the present invention of the silicone resin composition, it is preferable that the aluminosiloxane resin is prepared from a material component containing a condensation reaction type silicone resin and an aluminum atom complex, wherein the content ratio of the aluminum atom complex is 0.5 to 10 parts by mass with respect to 100 parts by mass of the material component.

In the present invention of the silicone resin composition, it is preferable that the condensation reaction type silicone resin contains an alkoxysilyl group-containing polysiloxane having basic constituent units of D unit and T unit, and an alkoxysilyl group-containing polysilsesquioxane having a basic constituent unit of T unit.

In the present invention of the silicone resin composition, it is preferable that the aluminum atom complex is trialkoxy aluminum.

In the present invention of the silicone resin composition, it is preferable that the aluminosiloxane resin is obtained by allowing the condensation reaction type silicone resin to react with the aluminum atom complex in a solvent containing water.

In the present invention of the silicone resin composition, it is preferable that reactive functional group-containing inorganic oxide particles are further contained.

In the present invention of the silicone resin composition, it is preferable that the reactive functional group-containing inorganic oxide particles are colloidal silica.

In the present invention of the silicone resin composition, it is preferable that the aluminosiloxane resin is obtained by allowing the condensation reaction type silicone resin to react with the aluminum atom complex in a mixed solvent which is prepared from water and an alcohol and contains the reactive functional group-containing inorganic oxide particles.

A method for producing a silicone resin composition of the present invention includes the steps of preliminarily preparing a material component by blending a condensation reaction type silicone resin with an aluminum atom complex; preparing an aluminosiloxane resin by allowing the material component to be reacted; and blending the aluminosiloxane resin with aluminum nitride.

In the producing method of the silicone resin composition of the present invention, it is preferable that in the preliminarily preparing step, the reactive functional group-containing inorganic oxide particles are further blended.

A thermal conductive sheet of the present invention is a thermal conductive sheet formed by allowing a silicone resin composition to be applied, wherein the silicone resin composition contains an aluminosiloxane resin containing an Al—O—Si bond and aluminum nitride.

In the silicone resin composition of the present invention, the aluminosiloxane resin and the aluminum nitride are contained.

Therefore, an aluminum atom is contained in both of the aluminosiloxane resin and the aluminum nitride, so that the dispersibility of the aluminum nitride in the aluminosiloxane resin is improved and the thermal conductivity of the silicone resin composition can be improved. That is, the thermal conductivity of the silicone resin composition can be improved without increasing the proportion of the aluminum nitride content.

Accordingly, in the silicone resin composition of the present invention, the flexibility and the thermal conductivity can be improved.

### BRIEF DESCRIPTION OF THE DRAWINGS

FIG. 1 shows process drawings for illustrating the steps for producing one embodiment of a thermal conductive sheet of the present invention:

(a) illustrating a step of preparing a release sheet and

(b) illustrating a step of forming the thermal conductive sheet.

### DETAILED DESCRIPTION OF THE INVENTION

### 1. The First Eembodiment of a Silicone Resin Composition of the Present Invention

A silicone resin composition (the first embodiment of a silicone resin composition of the present invention) contains a borosiloxane resin containing a B—O—Si bond and boron nitride.

The borosiloxane resin is, for example, prepared from a material component containing a condensation reaction type silicone resin and a boron atom complex.

The content ratio of the condensation reaction type silicone resin is, for example, 90 to 99.5 parts by mass, or preferably 95 to 99.5 parts by mass with respect to 100 parts by mass of the material component.

Examples of the condensation reaction type silicone resin include a silanol group-containing polysiloxane (for example, a polysiloxane containing silanol groups at both ends and the like) and an alkoxysilyl group-containing polysiloxane (for example, an alkoxysilyl group-containing polysiloxane having basic constituent units of D unit and T unit (hereinafter, defined as an alkoxysilyl group-containing polysiloxane having D·T unit), an alkoxysilyl group-containing polysilsesquioxane having a basic constituent unit of T unit (hereinafter, defined as an alkoxysilyl group-containing polysilsesquioxane), and the like).

The condensation reaction type silicone resins can be used alone or in combination.

Of the condensation reaction type silicone resins, preferably, an alkoxysilyl group-containing polysiloxane is used, or more preferably, an alkoxysilyl group-containing polysiloxane having D·T unit and an alkoxysilyl group-containing polysilsesquioxane are used in combination.

To be specific, the alkoxysilyl group-containing polysiloxane having D·T unit contains D unit represented in the following general formula (1) and T unit represented in the following general formula (2) as basic constituent units.

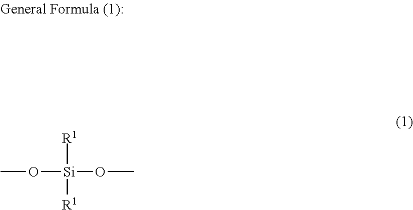

(where, in general formula (1), R¹ represents a monovalent hydrocarbon group selected from a saturated hydrocarbon group and an aromatic hydrocarbon group.)

In the above-described general formula (1), in the monovalent hydrocarbon group represented by R¹, examples of the saturated hydrocarbon group include a straight chain or branched chain alkyl group having 1 to 6 carbon atoms (such as a methyl group, an ethyl group, a propyl group, an isopropyl group, a butyl group, an isobutyl group, a pentyl group, and a hexyl group) and a cycloalkyl group having 3 to 6 carbon atoms (such as a cyclopentyl group and a cyclohexyl group).

In the above-described general formula (1), in the monovalent hydrocarbon group represented by R¹, an example of the aromatic hydrocarbon group includes an aryl group having 6 to 10 carbon atoms (such as a phenyl group and a naphthyl group).

In the above-described general formula (1), R¹ may be the same or different from each other. Preferably, R¹ is the same.

As the monovalent hydrocarbon group, preferably, an alkyl group having 1 to 6 carbon atoms and an aryl group having 6 to 10 carbon atoms are used, or more preferably, a methyl group is used.

D unit represented in the above-described general formula (1) may be the same or different from each other in the alkoxysilyl group-containing polysiloxane having D•T unit. Preferably, D unit represented in the above-described general formula (1) is the same.

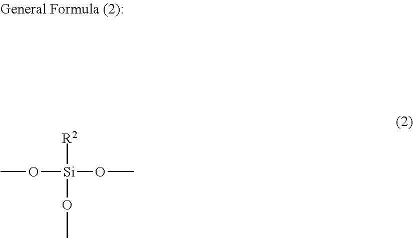

(where, in general formula (2), R² represents a monovalent hydrocarbon group selected from a saturated hydrocarbon group and an aromatic hydrocarbon group.)

In the above-described general formula (2), an example of the monovalent hydrocarbon group represented by R² includes the same monovalent hydrocarbon group as that represented by R¹ in the above-described general formula (1).

As the monovalent hydrocarbon group, preferably, an alkyl group having 1 to 6 carbon atoms and an aryl group having 6 to 10 carbon atoms are used, or more preferably, a methyl group is used.

T unit represented in the above-described general formula (2) may be the same or different from each other in the alkoxysilyl group-containing polysiloxane having D·T unit. Preferably, T unit represented in the above-described general formula (2) is the same.

The alkoxysilyl group-containing polysiloxane having D·T unit contains a partial condensation product of a silicone monomer (for example, a partial condensation product of dialkyl (or aryl) dialkoxysilane and alkyl (or aryl) trialkoxysilane) and contains, in its constituent unit, for example, the constituent unit represented in the following general formula (3). That is, the alkoxysilyl group-containing polysiloxane having D•T unit has, in one molecule, an alkoxysilyl group (—OR³ group in the following general formula (3)).

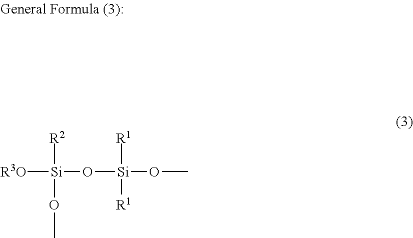

(where, in general formula (3), R¹ represents the same monovalent hydrocarbon group as that of R¹ in the above-described general formula (1) and R² represents the same monovalent hydrocarbon group as that of R² in the above-described general formula (2). R³ represents a monovalent hydrocarbon group selected from a saturated hydrocarbon group and an aromatic hydrocarbon group.)

In the above-described general formula (3), as the monovalent hydrocarbon group represented by R¹ and R², preferably, an alkyl group having 1 to 6 carbon atoms and an aryl group having 6 to 10 carbon atoms are used, or more preferably, a methyl group is used.

In the above-described general formula (3), R¹ may be the same or different from each other. Preferably, R¹ is the same.

In the above-described general formula (3), an example of the monovalent hydrocarbon group represented by R³ includes the same monovalent hydrocarbon group as that represented by R¹ in the above-described general formula (1).

Of the monovalent hydrocarbon groups, preferably, a saturated hydrocarbon group is used, more preferably, an alkyl group having 1 to 6 carbon atoms is used, or particularly preferably, a methyl group is used.

Examples of the alkoxysilyl group-containing polysiloxane having D•T unit include an alkoxysilyl group-containing polymethylsiloxane, an alkoxysilyl group-containing polymethylphenylsiloxane, and an alkoxysilyl group-containing polyphenylsiloxane.

The alkoxysilyl group-containing polysiloxanes having D•T unit can be used alone or in combination.

Of the alkoxysilyl group-containing polysiloxanes having D•T unit, preferably, a methoxysilyl group-containing polysiloxane is used, or more preferably, a methoxysilyl group-containing polymethylsiloxane is used.

The content of the alkoxysilyl group in the alkoxysilyl group-containing polysiloxane having D•T unit is, for example, 5 to 30 mass %, or preferably 7 to 20 mass %.

The number average molecular weight (GPC measurement with standard polystyrene calibration) of the alkoxysilyl group-containing polysiloxane having D•T unit is, for example, 150 to 10000, or preferably 800 to 6000.

The content ratio of the alkoxysilyl group-containing polysiloxane having D•T unit is, for example, 20 to 99.5 parts by mass, or preferably 30 to 70 parts by mass with respect to 100 parts by mass of the material component.

A commercially available product (trade name: X-40-9246, manufactured by Shin-Etsu Chemical Co., Ltd.) can be used as the alkoxysilyl group-containing polysiloxane having D•T unit.

To be specific, the alkoxysilyl group-containing polysilsesquioxane contains T unit represented in the above-described general formula (2) as a basic constituent unit.

T unit represented in the above-described general formula (2) may be the same or different from each other in the alkoxysilyl group-containing polysilsesquioxane. Preferably, T unit represented in the above-described general formula (2) is the same.

The alkoxysilyl group-containing polysilsesquioxane is a partial condensation product of a silicone monomer (for example, a partial condensation product of alkyl (or aryl) trialkoxysilane) and contains, in its constituent unit, for example, the constituent unit represented in the following general formula (4) and/or the following general formula (5). That is, the alkoxysilyl group-containing polysilsesquioxane has, in one molecule, an alkoxysilyl group (—OR³ group in the following general formulas (4) and (5)).

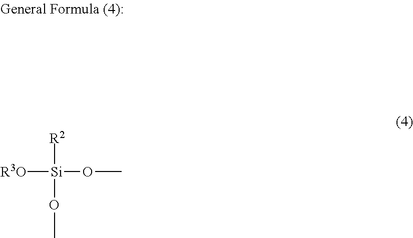

(where, in general formula (4), R² represents the same monovalent hydrocarbon group as that of R² in the above-described general formula (2) and R³ represents the same monovalent hydrocarbon group as that of R³ in the above-described general formula (3).)

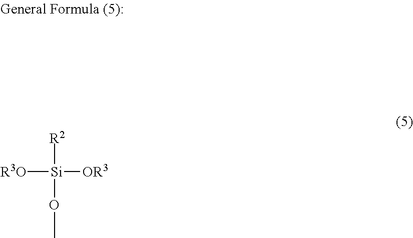

(where, in general formula (5), R² represents the same monovalent hydrocarbon group as that of R² in the above-described general formula (2) and R³ represents the same monovalent hydrocarbon group as that of R³ in the above-described general formula (3).)

In the above-described general formulas (4) and (5), as the monovalent hydrocarbon group represented by R², preferably, an alkyl group having 1 to 6 carbon atoms and an aryl group having 6 to 10 carbon atoms are used, or more preferably, a methyl group is used.

In the above-described general formulas (4) and (5), as the monovalent hydrocarbon group represented by R³, preferably, a saturated hydrocarbon group is used, more preferably, an alkyl group having 1 to 6 carbon atoms is used, or particularly preferably, a methyl group is used.

Examples of the alkoxysilyl group-containing polysilsesquioxane include alkoxysilyl group-containing polysilsesquioxanes having various structures such as a random structure, a ladder structure, and a cage structure.

The alkoxysilyl group-containing polysilsesquioxanes can be used alone or in combination.

Of the alkoxysilyl group-containing polysilsesquioxanes, preferably, a methoxysilyl group-containing polysilsesquioxane is used, or more preferably, a methoxysilyl group-containing polymethylsilsesquioxane is used.

The content of the alkoxysilyl group in the alkoxysilyl group-containing polysilsesquioxane is, for example, 10 to 50 mass %, or preferably 15 to 46 mass %.

The number average molecular weight (GPC measurement with standard polystyrene calibration) of the alkoxysilyl group-containing polysilsesquioxane is, for example, 400 to 3000, or preferably 800 to 3000.

The content ratio of the alkoxysilyl group-containing polysilsesquioxane is, for example, 20 to 99.5 parts by mass, or preferably 20 to 60 parts by mass with respect to 100 parts by mass of the material component.

When the condensation reaction type silicone resin contains the alkoxysilyl group-containing polysiloxane having D•T unit and the alkoxysilyl group-containing polysilsesquioxane, the molar ratio of the alkoxysilyl group in the alkoxysilyl group-containing polysiloxane having D•T unit to the alkoxysilyl group in the alkoxysilyl group-containing polysilsesquioxane is, for example, 1/3 to 3/1, or preferably, 1/2 to 2/1.

A commercially available product (trade name: X-40-9225, manufactured by Shin-Etsu Chemical Co., Ltd.) can be used as the alkoxysilyl group-containing polysilsesquioxane.

To be specific, an example of the boron atom complex includes a boron atom complex represented by the following general formula (6).

General Formula (6):

B—(OX)₃ (6)

(where, in general formula (6), X represents a hydrogen atom or a monovalent hydrocarbon group selected from a saturated hydrocarbon group and an aromatic hydrocarbon group. X may be the same or different from each other.)

In the above-described general formula (6), an example of the monovalent hydrocarbon group represented by X includes the same monovalent hydrocarbon group as that represented by R¹ in the above-described general formula (1).

In the above-described general formula (6), X may be the same or different from each other. Preferably, X is the same.

Of the monovalent hydrocarbon groups, preferably, a saturated hydrocarbon group is used, more preferably, an alkyl group having 1 to 6 carbon atoms is used, or particularly preferably, an isopropyl group is used.

Examples of the boron atom complex include trialkoxy boron, boric acid, and triaryl borate. Preferably, trialkoxy boron is used.

To be specific, examples of the trialkoxy boron include trimethyl borate, triethyl borate, tripropyl borate, triisopropyl borate, and tributyl borate. Preferably, triisopropyl borate is used.

The content ratio of the boron atom complex is, for example, 0.5 to 10 parts by mass, or preferably 0.5 to 5 parts by mass with respect to 100 parts by mass of the material component.

The molar ratio (Si/B) of the silicon atom in the condensation reaction type silicone resin to the boron atom in the boron atom complex is, for example, 100/1 to 100/10, preferably 100/1 to 100/8, or more preferably 100/1 to 100/6.

The content ratio of the borosiloxane resin is, for example, 20 to 80 parts by mass, or preferably 30 to 70 parts by mass with respect to 100 parts by mass of the silicone resin composition.

The boron nitride is a thermal conductive filler for imparting thermal conductivity to the silicone resin composition.

The boron nitride is, for example, formed into a plate-like (or flake-like) shape and is dispersed in the borosiloxane resin in a thermal conductive sheet (described later).

When the boron nitride is a plate-like shape, the boron nitride has an average length in the longitudinal direction (the maximum length in the direction perpendicular to the thickness direction of the plate) of, for example, 1 to 100 μm, or preferably 3 to 90 μm. The boron nitride particle has an average length in the longitudinal direction of, 5 μm or more, preferably 10 μm or more, more preferably 20 μm or more, particularly preferably, 30 μm or more, or most preferably 40 μm or more, and usually has an average length in the longitudinal direction of, for example, 100 μm or less, or preferably 90 μm or less.

The average thickness (the length in the thickness direction of the plate, that is, the length in the short-side direction of the particle) of the boron nitride is, for example, 0.01 to 20 μm, or preferably 0.1 to 15 μm.

The aspect ratio (the length in the longitudinal direction/the thickness) of the boron nitride is, for example, 2 to 10000, or preferably 10 to 5000.

The average particle size of the boron nitride as measured by a light scattering method is, for example, 5 μm or more, preferably 10 μm or more, more preferably 20 μm or more, particularly preferably 30 μm or more, or most preferably 40 μm or more, and usually is 100 μm or less.

The average particle size as measured by the light scattering method is a volume average particle size measured with a dynamic light scattering type particle size distribution analyzer.

When the average particle size of the boron nitride as measured by the light scattering method is below the above-described range, the thermal conductive sheet (described later) may become fragile and the handling ability may be reduced.

The bulk density (JIS K 5101, apparent density) of the boron nitride is, for example, 0.3 to 1.5 g/cm³, or preferably 0.5 to 1.0 g/cm³.

The thermal conductivity of the boron nitride is, for example, 10 to 70 W/m·K, or preferably 20 to 70 W/m·K.

The thermal conductivity can be measured with, for example, a xenonflash analyzer (trade name: LFA 447, manufactured by Erich NETZSCH GmbH & Co. Holding KG).

As the boron nitride, a commercially available product or processed products thereof can be used. Examples of the commercially available product of the boron nitride include “PT” series (for example, “PT-110”) manufactured by Momentive Performance Materials Inc., and the “SHOBN®UHP” series (for example, “SHOBN®UHP-1” manufactured by Showa Denko K.K.

The content ratio of the boron nitride is, for example, 10 to 80 parts by mass, or preferably 30 to 70 parts by mass with respect to 100 parts by mass of the silicone resin composition.

Preferably, the silicone resin composition contains reactive functional group-containing inorganic oxide particles.

The reactive functional group-containing inorganic oxide particles are inorganic oxide particles having a reactive functional group on the surfaces of the particles.

Examples of the reactive functional group include a hydroxyl group, an isocyanate group, a carboxy group, an epoxy group, an amino group, a mercapto group, a vinyl type unsaturated group, a halogen group, and an isocyanurate group.

Of the reactive functional groups, preferably, a hydroxyl group is used.

Examples of the inorganic oxide particles include titanium oxide, zirconium oxide, barium titanate, zinc oxide, lead titanate, and silica (silicon dioxide). Preferably, titanium dioxide, zirconium dioxide, zinc oxide, and silica are used, or more preferably, colloidal silica is used.

The inorganic oxide particles can be used alone or in combination.

The average primary particle size of the inorganic oxide particles is, for example, 1 to 100 nm, or preferably 1 to 50 nm.

The average primary particle size can be measured by a dynamic light scattering method or the like.

The reactive functional group-containing inorganic oxide particles are, for example, prepared as a sol of the inorganic oxide particles. Preferably, a colloidal silica sol is used.

The content ratio of the reactive functional group-containing inorganic oxide particles is, for example, 1 to 40 parts by mass, preferably 1 to 30 parts by mass, or more preferably 1 to 15 parts by mass with respect to 100 parts by mass of the condensation reaction type silicone resin and is, for example, 1 to 18 parts by mass, or preferably 1 to 14 parts by mass with respect to 100 parts by mass of the silicone resin composition.

A known additive can further be added to the above-described silicone resin composition at an appropriate ratio as required. Examples of the known additive include antioxidants, modifiers, surfactants, pigments, and discoloration inhibitors.

Next, a preparing method of the silicone resin composition (the first embodiment of a silicone resin composition of the present invention) is described.

To prepare the silicone resin composition, first, the condensation reaction type silicone resin and the boron atom complex are mixed (blended) at the above-described content ratio to prepare the material component (the preliminarily preparing step).

Examples of the mixing method of the condensation reaction type silicone resin and the boron atom complex include a dry mixing and a wet mixing. Preferably, a wet mixing is used.

To be specific, in a solvent, the condensation reaction type silicone resin and the boron atom complex are stirred and mixed.

Examples of the solvent include water and an alcohol such as methanol, ethanol, 2-propanol, and 2-methoxyethanol.

The solvents can be used alone or in combination.

Of the solvents, preferably, a mixed solvent of water and the alcohol is used, or more preferably, a mixed solvent of water and 2-propanol, and a mixed solvent of water, 2-propanol, and 2-methoxyethanol are used.

Mixing conditions are as follows: a temperature of, for example, 40 to 90° C., or preferably 40 to 80° C. and a duration of, for example, 1 to 6 hours, or preferably 2 to 4 hours.

As described above, the material component dissolved in the solvent is prepared.

Next, the condensation reaction type silicone resin and the boron atom complex in the material component are allowed to react to prepare the borosiloxane resin (the preparing step).

When the condensation reaction type silicone resin contains the alkoxysilyl group-containing polysiloxane (to be specific, the alkoxysilyl group-containing polysiloxane having D•T unit and the alkoxysilyl group-containing polysilsesquioxane), the pH of the solvent is adjusted to 2 to 4 by, for example, an acid component, so that the alkoxysilyl group is hydrolyzed to produce a silanol group.

Examples of the acid component include an aqueous solution of inorganic acid such as hydrochloric acid, nitric acid, sulfuric acid, and phosphoric acid and an aqueous solution of organic acid such as acetic acid. Preferably, an aqueous solution of inorganic acid is used, or more preferably, an aqueous solution of nitric acid is used.

To be specific, in order to allow the condensation reaction type silicone resin to react with the boron atom complex, the condensation reaction type silicone resin is allowed to react with the boron atom complex by heating, so that the borosiloxane resin is prepared.

Reaction conditions of the condensation reaction type silicone resin with the boron atom complex are as follows: a temperature of, for example, 40 to 90° C., or preferably 40 to 80° C. and a duration of, for example, 1 to 6 hours, or preferably 2 to 5 hours.

As described above, the borosiloxane resin is prepared.

In this way, the borosiloxane resin contains a B—O—Si bond produced by allowing the silanol group in the condensation reaction type silicone resin (in the case of the alkoxysilyl group-containing polysiloxane, the silanol group produced by hydrolysis of the alkoxysilyl group) to react with the hydroxyl group or the alkoxy group in the boron atom complex.

The B—O—Si bond is identified by, for example, ¹H-NMR, IR Spectrum, or the like.

In the above-described preliminarily preparing step, the reactive functional group-containing inorganic oxide particles are blended as required.

To be specific, the above-described solvent whose pH is adjusted to 2 to 4 by the above-described acid component is allowed to contain the reactive functional group-containing inorganic oxide particles. Then, the condensation reaction type silicone resin and the boron atom complex are added thereto to be mixed.

When the condensation reaction type silicone resin contains the alkoxysilyl group-containing polysiloxane having D•T unit and the alkoxysilyl group-containing polysilsesquioxane, first, a silsesquioxane solution in which the alkoxysilyl group-containing polysilsesquioxane and the boron atom complex are dissolved in the above-described solvent (for example, 2-propanol) is added dropwise to the solvent containing the reactive functional group-containing inorganic oxide particles.

Then, a polysiloxane solution in which the alkoxysilyl group-containing polysiloxane having D•T unit is dissolved in the above-described solvent (for example, 2-propanol) is added dropwise to the liquid mixture thereof to prepare the material component.

The concentration of the alkoxysilyl group-containing polysilsesquioxane in the silsesquioxane solution is, for example, 10 to 80 mass %, or preferably 30 to 70 mass % and the concentration of the boron atom complex is, for example, 0.1 to 10 mass %, or preferably 0.1 to 7 mass %.

The concentration of the alkoxysilyl group-containing polysiloxane having D•T unit in the polysiloxane solution is, for example, 10 to 80 mass %, or preferably 30 to 70 mass %.

As described above, the material component, which is dissolved in the solvent and contains the reactive functional group-containing inorganic oxide particles as required, is prepared.

Next, by heating the material component, the condensation reaction type silicone resin (to be specific, the alkoxysilyl group-containing polysiloxane having D•T unit and the alkoxysilyl group-containing polysilsesquioxane) is allowed to react with the boron atom complex to prepare the borosiloxane resin.

Reaction conditions are as follows: a temperature of, for example, 40 to 130° C., or preferably 80 to 120° C. and a duration of, for example, 1 to 6 hours, or preferably 1 to 5 hours.

When the borosiloxane resin contains the reactive functional group-containing inorganic oxide particles, the reactive functional group in the reactive functional group-containing inorganic oxide particles is bonded to the borosiloxane resin via a covalent bond or a hydrogen bond.

As described above, the borosiloxane resin, which contains the reactive functional group-containing inorganic oxide particles as required, is prepared.

Next, the borosiloxane resin and the boron nitride are blended at the above-described content ratio to be stirred and mixed, so that the silicone resin composition is prepared (the blending step).

Mixing conditions are as follows: a temperature of, for example, 20 to 90° C., or preferably 25 to 70° C. and a duration of, for example, 0.1 to 5 hours, or preferably 0.5 to 4 hours.

As described above, the silicone resin composition (the first embodiment of a silicone resin composition of the present invention) is prepared.

The silicone resin composition (the first embodiment of a silicone resin composition of the present invention) of the present invention obtained in this way contains the borosiloxane resin and the boron nitride.

Therefore, the boron atom is contained in both of the borosiloxane resin and the boron nitride, so that the affinity between the borosiloxane resin and the boron nitride is improved and the dispersibility of the boron nitride can be improved.

As a result, the thermal conductivity of the silicone resin composition can be improved. That is, the thermal conductivity of the silicone resin composition can be improved without increasing the proportion of the boron nitride content.

### 2. The Second Embodiment of a Silicone Resin Composition of the Present Invention

The silicone resin composition (the second embodiment of a silicone resin composition of the present invention) contains an aluminosiloxane resin containing an Al—O—Si bond and aluminum nitride.

The aluminosiloxane resin is, for example, prepared from a material component containing the above-described condensation reaction type silicone resin and an aluminum atom complex.

The content ratio of the condensation reaction type silicone resin is, for example, 50 to 99.5 parts by mass, or preferably 80 to 99.5 parts by mass with respect to 100 parts by mass of the material component.

The condensation reaction type silicone resins can be used alone or in combination.

Of the condensation reaction type silicone resins, preferably, the above-described alkoxysilyl group-containing polysiloxane is used, or more preferably, the above-described alkoxysilyl group-containing polysiloxane having D•T unit and the above-described alkoxysilyl group-containing polysilsesquioxane are used in combination.

The alkoxysilyl group-containing polysiloxanes having D•T unit can be used alone or in combination.

The content of the alkoxysilyl group in the alkoxysilyl group-containing polysiloxane having D•T unit is, for example, 5 to 30 mass %, or preferably 7 to 15 mass %.

The number average molecular weight (GPC measurement with standard polystyrene calibration) of the alkoxysilyl group-containing polysiloxane having D•T unit is, for example, 150 to 10000, or preferably 500 to 6000.

The content ratio of the alkoxysilyl group-containing polysiloxane having D•T unit is, for example, 20 to 99.5 parts by mass, or preferably 30 to 70 parts by mass with respect to 100 parts by mass of the material component.

A commercially available product (trade name: X-40-9246, manufactured by Shin-Etsu Chemical Co., Ltd.) can be used as the alkoxysilyl group-containing polysiloxane having D•T unit.

The alkoxysilyl group-containing polysilsesquioxanes can be used alone or in combination.

Of the alkoxysilyl group-containing polysilsesquioxanes, preferably, a methoxysilyl group-containing polysilsesquioxane is used, or more preferably, a methoxysilyl group-containing polymethylsilsesquioxane is used.

The content of the alkoxysilyl group in the alkoxysilyl group-containing polysilsesquioxane is, for example, 10 to 50 mass %, or preferably 15 to 46 mass %.

The number average molecular weight (GPC measurement with standard polystyrene calibration) of the alkoxysilyl group-containing polysilsesquioxane is, for example, 300 to 4000, or preferably 500 to 2000.

The content ratio of the alkoxysilyl group-containing polysilsesquioxane is, for example, 20 to 99.5 parts by mass, or preferably 20 to 60 parts by mass with respect to 100 parts by mass of the material component.

When the condensation reaction type silicone resin contains the alkoxysilyl group-containing polysiloxane having D•T unit and the alkoxysilyl group-containing polysilsesquioxane, the molar ratio of the alkoxysilyl group in the alkoxysilyl group-containing polysiloxane having D•T unit to the alkoxysilyl group in the alkoxysilyl group-containing polysilsesquioxane is, for example, 1/3 to 3/1, or preferably, 1/2 to 2/1.

A commercially available product (trade name: X-40-9225, manufactured by Shin-Etsu Chemical Co., Ltd.) can be used as the alkoxysilyl group-containing polysilsesquioxane.

To be specific, an example of the aluminum atom complex includes an aluminum atom complex represented by the following general formula (7).

General Formula (7):

Al—(OY)₃ (7)

(where, in general formula (7), Y represents a hydrogen atom or a monovalent hydrocarbon group selected from a saturated hydrocarbon group and an aromatic hydrocarbon group. Y may be the same or different from each other.)

In the above-described general formula (7), an example of the monovalent hydrocarbon group represented by Y includes the same monovalent hydrocarbon group as that represented by R¹ in the above-described general formula (1).

In the above-described general formula (7), Y may be the same or different from each other. Preferably, Y is the same.

Of the monovalent hydrocarbon groups, preferably, a saturated hydrocarbon group is used, more preferably, an alkyl group having 1 to 6 carbon atoms is used, or particularly preferably, an isopropyl group is used.

Examples of the aluminum atom complex include trialkoxy aluminum, aluminum hydroxide, and triaryloxy aluminum. Preferably, trialkoxy aluminum is used.

To be specific, examples of the trialkoxy aluminum include trimethoxy aluminum, triethoxy aluminum, tripropoxy aluminum, triisopropoxy aluminum, and tributoxy aluminum. Preferably, triisopropoxy aluminum is used.

The content ratio of the aluminum atom complex is, for example, 0.5 to 10 parts by mass, or preferably 0.5 to 5 parts by mass with respect to 100 parts by mass of the material component.

The molar ratio (Si/Al) of the silicon atom in the condensation reaction type silicone resin to the aluminum atom in the aluminum atom complex is, for example, 100/1 to 100/10, preferably 100/1 to 100/7, or more preferably 100/1 to 100/5.

The content ratio of the aluminosiloxane resin is, for example, 20 to 80 parts by mass, or preferably 30 to 70 parts by mass with respect to 100 parts by mass of the silicone resin composition.

The aluminum nitride is a thermal conductive filler for imparting thermal conductivity to the silicone resin composition.

The aluminum nitride is, for example, formed into a powder-like shape and is dispersed in the aluminosiloxane resin in a thermal conductive sheet (described later).

The average particle size (the primary particle size) of the aluminum nitride as measured by a light scattering method is, for example, 0.5 μm or more, preferably 0.6 μm or more, more preferably 0.7 μm or more, particularly preferably 0.8 μm or more, or most preferably 1 μm or more, and usually is 2 μm or less.

The average particle size (the primary particle size) as measured by the light scattering method is a volume average particle size measured with a dynamic light scattering type particle size distribution analyzer.

When the average particle size of the aluminum nitride as measured by the light scattering method is below the above-described range, the thermal conductive sheet (described later) may become fragile and the handling ability may be reduced.

The bulk density (JIS K 5101, apparent density) of the aluminum nitride is, for example, 0.35 to 0.6 g/cm³, or preferably 0.4 to 0.5 g/cm³.

The thermal conductivity of the aluminum nitride is, for example, 60 to 200 W/m·K, or preferably 80 to 200 W/m·K.

The thermal conductivity can be measured with, for example, a xenonflash analyzer (trade name: LFA 447, manufactured by Erich NETZSCH GmbH & Co. Holding KG).

As the aluminum nitride, a commercially available product or processed products thereof can be used. An example of the commercially available product of the aluminum nitride includes Shapal® manufactured by Tokuyama Corporation.

The content ratio of the aluminum nitride is, for example, 10 to 80 parts by mass, or preferably 30 to 70 parts by mass with respect to 100 parts by mass of the silicone resin composition.

Preferably, the silicone resin composition contains the above-described reactive functional group-containing inorganic oxide particles.

The reactive functional group-containing inorganic oxide particles are, for example, prepared as a sol of the inorganic oxide particles. Preferably, a colloidal silica sol is used.

The content ratio of the reactive functional group-containing inorganic oxide particles is, for example, 1 to 40 parts by mass, preferably 1 to 30 parts by mass, or more preferably 1 to 15 parts by mass with respect to 100 parts by mass of the condensation reaction type silicone resin and is, for example, 0.1 to 20 parts by mass, preferably 0.1 to 15 parts by mass, or more preferably 0.1 to 5 parts by mass with respect to 100 parts by mass of the silicone resin composition.

The above-described known additive can further be added to the above-described silicone resin composition at an appropriate ratio as required.

Next, a preparing method of the silicone resin composition (the second embodiment of a silicone resin composition of the present invention) is described.

To prepare the silicone resin composition, first, the condensation reaction type silicone resin and the aluminum atom complex are mixed (blended) at the above-described content ratio to prepare the material component (the preliminarily preparing step).

Examples of the mixing method of the condensation reaction type silicone resin and the aluminum atom complex include a dry mixing and a wet mixing. Preferably, a wet mixing is used.

To be specific, in the above-described solvent, the condensation reaction type silicone resin and the aluminum atom complex are stirred and mixed.

The solvents can be used alone or in combination.

Of the solvents, preferably, a mixed solvent of water and the alcohol is used, or more preferably, a mixed solvent of water and 2-propanol, and a mixed solvent of water, 2-propanol, and 2-methoxyethanol are used.

Mixing conditions are as follows: a temperature of, for example, 40 to 90° C., or preferably 40 to 80° C. and a duration of, for example, 1 to 6 hours, or preferably 2 to 5 hours.

As described above, the material component dissolved in the solvent is prepared.

Next, the condensation reaction type silicone resin and the aluminum atom complex in the material component are allowed to react to prepare the aluminosiloxane resin (the preparing step).

When the condensation reaction type silicone resin contains the alkoxysilyl group-containing polysiloxane (to be specific, the alkoxysilyl group-containing polysiloxane having D•T unit and the alkoxysilyl group-containing polysilsesquioxane), the pH of the solvent is adjusted to 2 to 4 by, for example, the above-described acid component, so that the alkoxysilyl group is hydrolyzed to produce a silanol group.

To be specific, in order to allow the condensation reaction type silicone resin to react with the aluminum atom complex, the condensation reaction type silicone resin is allowed to react with the aluminum atom complex by heating, so that the aluminosiloxane resin is prepared.

Reaction conditions of the condensation reaction type silicone resin with the aluminum atom complex are as follows: a temperature of, for example, 40 to 90° C., or preferably 40 to 80° C. and a duration of, for example, 1 to 6 hours, or preferably 2 to 5 hours.

As described above, the aluminosiloxane resin is prepared.

In this way, the aluminosiloxane resin contains an Al—O—Si bond produced by allowing the silanol group in the condensation reaction type silicone resin (in the case of the alkoxysilyl group-containing polysiloxane, the silanol group produced by hydrolysis of the alkoxysilyl group) to react with the hydroxyl group or the alkoxy group in the aluminum atom complex .

The Al—O—Si bond is identified by, for example, ¹H-NMR, IR Spectrum, or the like.

In the above-described preliminarily preparing step, the reactive functional group-containing inorganic oxide particles are blended as required.

To be specific, the above-described solvent whose pH is adjusted to 2 to 4 by the above-described acid component is allowed to contain the reactive functional group-containing inorganic oxide particles. Then, the condensation reaction type silicone resin and the aluminum atom complex are added thereto to be mixed.

When the condensation reaction type silicone resin contains the alkoxysilyl group-containing polysiloxane having D•T unit and the alkoxysilyl group-containing polysilsesquioxane, first, a silsesquioxane solution in which the alkoxysilyl group-containing polysilsesquioxane and the aluminum atom complex are dissolved in the above-described solvent (for example, 2-propanol) is added dropwise to the solvent containing the reactive functional group-containing inorganic oxide particles.

Then, a polysiloxane solution in which the alkoxysilyl group-containing polysiloxane having D•T unit is dissolved in the above-described solvent (for example, 2-propanol) is added dropwise to the liquid mixture thereof to prepare the material component.

The concentration of the alkoxysilyl group-containing polysilsesquioxane in the silsesquioxane solution is, for example, 10 to 80 mass %, or preferably 30 to 70 mass % and the concentration of the aluminum atom complex is, for example, 0.1 to 10 mass %, or preferably 0.1 to 7 mass %.

The concentration of the alkoxysilyl group-containing polysiloxane having D•T unit in the polysiloxane solution is, for example, 10 to 80 mass %, or preferably 30 to 70 mass %.

As described above, the material component, which is dissolved in the solvent and contains the reactive functional group-containing inorganic oxide particles as required, is prepared.

Next, by heating the material component, the condensation reaction type silicone resin (to be specific, the alkoxysilyl group-containing polysiloxane having D•T unit and the alkoxysilyl group-containing polysilsesquioxane) is allowed to react with the aluminum atom complex to prepare the aluminosiloxane resin.

Reaction conditions are as follows: a temperature of, for example, 40 to 130° C., or preferably 80 to 120° C. and a duration of, for example, 1 to 6 hours, or preferably 1 to 5 hours.

When the aluminosiloxane resin contains the reactive functional group-containing inorganic oxide particles, the reactive functional group in the reactive functional group-containing inorganic oxide particles is bonded to the aluminosiloxane resin via a covalent bond or a hydrogen bond.

As described above, the aluminosiloxane resin, which contains the reactive functional group-containing inorganic oxide particles as required, is prepared.

Next, the aluminosiloxane resin and the aluminum nitride are blended at the above-described content ratio to be stirred and mixed, so that the silicone resin composition is prepared (the blending step).

Mixing conditions are as follows: a temperature of, for example, 20 to 50° C., or preferably 20 to 40° C. and a duration of, for example, 0.1 to 3 hours, or preferably 0.1 to 1 hours.

As described above, the silicone resin composition (the second embodiment of a silicone resin composition of the present invention) is prepared.

The silicone resin composition (the second embodiment of a silicone resin composition of the present invention) of the present invention obtained in this way contains the aluminosiloxane resin and the aluminum nitride.

Therefore, the aluminum atom is contained in both of the aluminosiloxane resin and the aluminum nitride, so that the affinity between the aluminosiloxane resin and the aluminum nitride is improved and the dispersibility of the aluminum nitride can be improved.

As a result, the thermal conductivity of the silicone resin composition can be improved. That is, the thermal conductivity of the silicone resin composition can be improved without increasing the proportion of the aluminum nitride content.

Accordingly, in the silicone resin composition (the first and second embodiments of the silicone resin composition of the present invention) of the present invention, the flexibility and the thermal conductivity can be improved.

Therefore, the silicone resin composition (the first and second embodiments of the silicone resin composition of the present invention) of the present invention can be used as a heat dissipating material in various industrial fields requiring flexibility. Preferably, the silicone resin composition (the first and second embodiments of the silicone resin composition of the present invention) of the present invention can be used as a thermal conductive sheet.

### 3. The Thermal Conductive Sheet

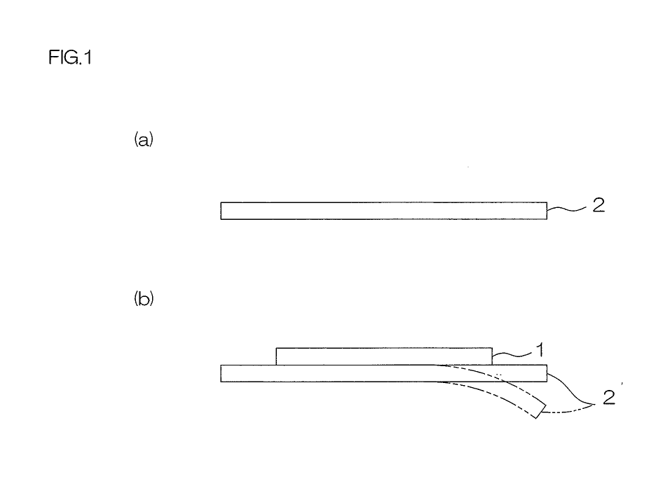

Next, a method for producing the thermal conductive sheet of the present invention is described with reference to FIG. 1.

In this method, as shown in FIG. 1(a), a release sheet 2 is first prepared.

The release sheet 2 is used as a coating substrate for a thermal conductive sheet 1.

Examples of the release sheet 2, though not particularly limited, include a polyester film such as a polyethylene terephthalate (PET) film; a polycarbonate film; a polyolefin film such as a polyethylene film and a polypropylene film; a polystylene film; an acrylic film; and a resin film such as a silicone resin film and a fluorine resin film.

Of the release sheets 2, preferably, a polyethylene terephthalate (PET) film is used.

A release treatment is performed on the top surface of the release sheet 2 as required so as to increase the release characteristics from the thermal conductive sheet 1.

The thickness of the release sheet 2 is not particularly limited and is, for example, 5 to 60 μm, or preferably 10 to 40 μm.

Next, as shown in FIG. 1(b), the silicone resin composition (the first or second embodiments of the silicone resin composition of the present invention) is laminated on the release sheet 2.

To laminate the silicone resin composition on the release sheet 2, first, the solvent of the silicone resin composition is removed to adjust the viscosity of the silicone resin composition.

At this time, when the silicone resin composition contains the borosiloxane resin and the boron nitride, the viscosity (at 25° C.) of the silicone resin composition is, for example, 0.1 to 40 Pa·s, or preferably 0.5 to 20 Pa·s.

When the silicone resin composition contains the aluminosiloxane resin and the aluminum nitride, the viscosity (at 25° C.) of the silicone resin composition is, for example, 0.1 to 20 Pa·s, or preferably 1 to 15 Pa·s.

The silicone resin composition whose viscosity is adjusted is, for example, applied on the release sheet 2 to be formed into a generally sheet shape, so that the thermal conductive sheet 1 is formed.

An example of the application method includes a known application method such as a casting, a spin coating, and a roll coating. Preferably, a casting method is used.

As described above, the thermal conductive sheet 1 is prepared.

The thickness of the thermal conductive sheet 1 is, for example, 50 to 500 μm, or preferably 100 to 300 μm.

When the silicone resin composition contains the borosiloxane resin and the boron nitride, the thermal conductivity of the thermal conductive sheet 1 is, for example, 0.5 to 6 W/m·K, or preferably 1 to 6 W/m·K.

When the silicone resin composition contains the aluminosiloxane resin and the aluminum nitride, the thermal conductivity of the thermal conductive sheet 1 is, for example, 0.5 to 10 W/m·K, or preferably 3 to 10 W/m·K.

The thermal conductive sheet 1 obtained in this way has an excellent flexibility and thermal conductivity.

Therefore, the thermal conductive sheet 1 can be used as a thermal conductive sheet, for example, used in power electronics technology, that is, a thermal conductive sheet, for example, applied in a heat dissipating material of optical semiconductor element and a covering material for electronic circuit.

### EXAMPLES

While the present invention will be described hereinafter in further detail with reference to Examples and Comparative Examples, the present invention is not limited to these Examples and Comparative Examples.

### Example 1

5.0 g of an alkoxysilyl group-containing polymethylsilsesquioxane (trade name: X-40-9225, manufactured by Shin-Etsu Chemical Co., Ltd., a number average molecular weight (GPC measurement with standard polystyrene calibration) of 800 to 1000, a methoxysilyl group content of 24 mass %) and 7.0 g of an alkoxysilyl group-containing polymethylsiloxane having D•T unit (trade name: X-40-9246, manufactured by Shin-Etsu Chemical Co., Ltd, a number average molecular weight (GPC measurement with standard polystyrene calibration) of 1000 to 2000, a methoxysilyl group content of 12 mass %) were dissolved in 33 g of a mixed solvent (30 g of 2-propanol and 3 g of water).

Next, 0.6 g of triisopropyl borate (manufactured by Wako Pure Chemical Industries, Ltd.) was added thereto to prepare a material component (the content ratio of the triisopropyl borate in the material component was 5 mass %).

Next, a concentrated nitric acid aqueous solution was added to a solution in which the material component was dissolved and the pH thereof was adjusted to about 2. The obtained mixture was heated and stirred at 70° C. for 5 hours.

In this way, the alkoxysilyl group-containing polymethylsilsesquioxane, the alkoxysilyl group-containing polymethylsiloxane having D•T unit, and triisopropyl borate were reacted to prepare a borosiloxane resin.

Next, 12 g of boron nitride (trade name: PT110, boron nitride in a plate-like shape, an average particle size (light scattering method) of 45 μm, manufactured by Momentive Performance Materials Inc.) was added to the borosiloxane resin to be stirred.

Then, the solvent was distilled off under reduced pressure to prepare a silicone resin composition.

The viscosity (at 25° C.) of the silicone resin composition was 2.5 Pa·s.

Next, the silicone resin composition was formed into a generally sheet shape by a casting to prepare a thermal conductive sheet. The thickness of the thermal conductive sheet was 200 μm.

### Example 2

3 g (solid content of 0.6 g) of colloidal silica (trade name: Snowtex OS, manufactured by NISSAN CHEMICAL INDUSTRIES, LTD., a solid content concentration of 20 mass %, an average primary particle size of 8 to 11 nm) was added to 7 g of a mixed solvent (5 g of 2-propanol and 2 g of 2-methoxyethanol). Next, a concentrated nitric acid aqueous solution was added thereto and the pH thereof was adjusted to about 2. In this way, water was added to the mixed solvent in addition to the 2-propanol and 2-methoxyethanol.

Next, after the temperature of the obtained mixture was increased to 70° C., a polymethylsilsesquioxane solution in which 5g of an alkoxysilyl group-containing polysilsesquioxane (trade name: X-40-9225, manufactured by Shin-Etsu Chemical Co., Ltd., a number average molecular weight (GPC measurement with standard polystyrene calibration) of 800 to 1000, a methoxysilyl group content of 24 mass %) and 0.6 g of triisopropyl borate (manufactured by Wako Pure Chemical Industries, Ltd.) were dissolved in 5 g of 2-propanol was added dropwise thereto over 1 hour using a dropping funnel.

Next, a polymethylsiloxane solution in which 7 g of an alkoxysilyl group-containing polymethylsiloxane having D•T unit (trade name: X-40-9246, manufactured by Shin-Etsu Chemical Co., Ltd., a number average molecular weight (GPC measurement with standard polystyrene calibration) of 1000 to 2000, a methoxysilyl group content of 12 mass %) was dissolved in 7 g of 2-propanol was added dropwise thereto over 1 hour using a dropping funnel.

In this way, a material component containing colloidal silica was prepared (the content ratio of the triisopropyl borate in the material component was 5 mass %).

Next, the material component was heated and stirred at 110° C. for 1 hour.

In this way, the alkoxysilyl group-containing polymethylsilsesquioxane, the alkoxysilyl group-containing polymethylsiloxane having D•T unit, and the triisopropyl borate were reacted to prepare a borosiloxane resin.

Next, 12 g of boron nitride (trade name: PT110, boron nitride in a plate-like shape, an average particle size (light scattering method) of 45 μm, manufactured by Momentive Performance Materials Inc.) was added to the borosiloxane resin to be stirred.

Then, the solvent was distilled off under reduced pressure to prepare a silicone resin composition.

The viscosity (at 25° C.) of the silicone resin composition was 8.2 Pa·s.

Next, the silicone resin composition was formed into a generally sheet shape by a casting to prepare a thermal conductive sheet. The thickness of the thermal conductive sheet was 200 μm.

### Example 3

5.0 g of an alkoxysilyl group-containing polymethylsilsesquioxane (trade name: X-40-9225, manufactured by Shin-Etsu Chemical Co., Ltd., a number average molecular weight (GPC measurement with standard polystyrene calibration) of 800 to 1000, a methoxysilyl group content of 24 mass %) and 7.0 g of an alkoxysilyl group-containing polymethylsiloxane having D•T unit (trade name: X-40-9246, manufactured by Shin-Etsu Chemical Co., Ltd, a number average molecular weight (GPC measurement with standard polystyrene calibration) of 1000 to 2000, a methoxysilyl group content of 12 mass %) were dissolved in 33 g of a mixed solvent (30 g of 2-propanol and 3 g of water).

Next, 0.6 g of triisopropoxy aluminum (manufactured by Wako Pure Chemical Industries, Ltd.) was added thereto to prepare a material component (the content ratio of the triisopropoxy aluminum in the material component was 5 mass %).

Next, a concentrated nitric acid aqueous solution was added to a solution in which the material component was dissolved and the pH thereof was adjusted to about 2. The obtained mixture was heated and stirred at 70° C. for 5 hours.

In this way, the alkoxysilyl group-containing polymethylsilsesquioxane, the alkoxysilyl group-containing polymethylsiloxane having D•T unit, and triisopropoxy aluminum were reacted to prepare an aluminosiloxane resin.

Next, 12 g of aluminum nitride (trade name: Shapal®, aluminum nitride in a powder-like shape, an average particle size (light scattering method) of 1.1 μm, manufactured by Tokuyama Corporation) was added to the aluminosiloxane resin to be stirred.

Then, the solvent was distilled off under reduced pressure to prepare a silicone resin composition.

The viscosity (at 25° C.) of the silicone resin composition was 6.9 Pa·s.

Next, the silicone resin composition was formed into a generally sheet shape by a casting to prepare a thermal conductive sheet. The thickness of the thermal conductive sheet was 200 μm.

### Example 4

3 g (solid content of 0.6 g) of colloidal silica (trade name: Snowtex OS, manufactured by NISSAN CHEMICAL INDUSTRIES, LTD., a solid content concentration of 20 mass %, an average primary particle size of 8 to 11 nm) was added to 7 g of a mixed solvent (5 g of 2-propanol and 2 g of 2-methoxyethanol). Next, a concentrated nitric acid aqueous solution was added thereto and the pH thereof was adjusted to about 2. In this way, water was added to the mixed solvent in addition to the 2-propanol and 2-methoxyethanol.

Next, after the temperature of the obtained mixture was increased to 70° C., a polymethylsilsesquioxane solution in which 5g of an alkoxysilyl group-containing polymethylsilsesquioxane (trade name: X-40-9225, manufactured by Shin-Etsu Chemical Co., Ltd., a number average molecular weight (GPC measurement with standard polystyrene calibration) of 800 to 1000, a methoxysilyl group content of 24 mass %) and 0.6 g of triisopropoxy aluminum (manufactured by Wako Pure Chemical Industries, Ltd.) were dissolved in 5 g of 2-propanol was added dropwise thereto over 1 hour using a dropping funnel.

Next, a polymethylsiloxane solution in which 7 g of an alkoxysilyl group-containing polymethylsiloxane having D•T unit (trade name: X-40-9246, manufactured by Shin-Etsu Chemical Co., Ltd., a number average molecular weight (GPC measurement with standard polystyrene calibration) of 1000 to 2000, a methoxysilyl group content of 12 mass %) was dissolved in 7 g of 2-propanol was added dropwise thereto over 1 hour using a dropping funnel.

In this way, a material component containing colloidal silica was prepared (the content ratio of the triisopropoxy aluminum in the material component was 5 mass %).

Next, the material component was heated and stirred at 110° C. for 1 hour.

In this way, the alkoxysilyl group-containing polymethylsilsesquioxane, the alkoxysilyl group-containing polymethylsiloxane having D•T unit, and triisopropoxy aluminum were reacted to prepare an aluminosiloxane resin.

Next, 12 g of aluminum nitride (trade name: Shapal®, aluminum nitride in a powder-like shape, an average particle size (light scattering method) of 1.1 μm, manufactured by Tokuyama Corporation) was added to the aluminosiloxane resin to be stirred.

Then, the solvent was distilled off under reduced pressure to prepare a silicone resin composition.

The viscosity (at 25° C.) of the silicone resin composition was 7.8 Pa·s.

Next, the silicone resin composition was formed into a generally sheet shape by a casting to prepare a thermal conductive sheet. The thickness of the thermal conductive sheet was 200 μm.

### Comparative Example 1

A silicone resin composition and a thermal conductive sheet were produced in the same manner as in Example 1, except that 0.6 g of triisopropyl borate was not added.

The viscosity (at 25° C.) of the silicone resin composition was 3.5 Pa·s.

### Comparative Example 2

A silicone resin composition and a thermal conductive sheet were produced in the same manner as in Example 2, except that 0.6 g of triisopropyl borate was not added.

The viscosity (at 25° C.) of the silicone resin composition was 6.8 Pa·s.

### Comparative Example 3

A silicone resin composition and a thermal conductive sheet were produced in the same manner as in Example 3, except that 0.6 g of triisopropoxy aluminum was not added.

The viscosity (at 25° C.) of the silicone resin composition was 4.3 Pa·s.

### Comparative Example 4

A silicone resin composition and a thermal conductive sheet were produced in the same manner as in Example 4, except that 0.6 g of triisopropoxy aluminum was not added.

The viscosity (at 25° C.) of the silicone resin composition was 6.2 Pa·s.

(Evaluation)

1. Thermal Conductivity Measurement

The thermal conductivity of the thermal conductive sheets in Examples and Comparative Examples was measured with a xenonflash analyzer (trade name: LFA 447, manufactured by Erich NETZSCH GmbH & Co. Holding KG). The results are shown in Tables 1 and 2.

2. Observation of Appearance

The appearance of the thermal conductive sheets in Examples and Comparative Examples was observed visually.

### (1) Examples 1 and 2, and Comparative Examples 1 and 2

The evaluation was conducted as follows: when a streak caused by an aggregation of the boron nitride was not confirmed on the appearance of the thermal conductive sheet, the thermal conductive sheet was evaluated as “Good” and when a streak caused by an aggregation of the boron nitride was confirmed thereon, the thermal conductive sheet was evaluated as “Bad”. The results are shown in Table 1. When the streak is not confirmed, the dispersibility of the boron nitride is excellent, so that the flexibility of the thermal conductive sheet is excellent.

### (2) Examples 3 and 4, and Comparative Examples 3 and 4

The evaluation was conducted as follows: when a streak caused by an aggregation of the aluminum nitride was not confirmed on the appearance of the thermal conductive sheet, the thermal conductive sheet was evaluated as “Good” and when a streak caused by an aggregation of the aluminum nitride was confirmed thereon, the thermal conductive sheet was evaluated as “Bad”. The results are shown in Table 2. When the streak is not confirmed, the dispersibility of the aluminum nitride is excellent, so that the flexibility of the thermal conductive sheet is excellent.

TABLE 1

| | | First Embodiment of | | | | |
|---|---|---|---|---|---|---|
| | | Silicone Resin | | | Comparative | Comparative |
| | | Composition | Example 1 | Example 2 | Example 1 | Example 2 |
| Silicone | Borosiloxane | Triisopropyl Borate | 0.6 | 0.6 | 0 | 0 |
| Resin | Resin | (Parts by Mass) | | | | |
| Composition | | Alkoxysilyl | 5 | 5 | 5 | 5 |
| | | Group-Containing | | | | |
| | | Polymethylsilsesquioxane | | | | |
| | | (Parts by Mass) | | | | |
| | | Alkoxysilyl | 7 | 7 | 7 | 7 |
| | | Group-Containing | | | | |
| | | Polymethylsiloxane | | | | |
| | | Having D · T Unit | | | | |
| | | (Parts by Mass) | | | | |

| | | | | | |
|---|---|---|---|---|---|
| | Colloidal Silica (Parts by Mass) | — | 3 (0.6) | — | 3 (0.6) |
| | Boron Nitride (Parts by Mass) | 12 | 12 | 12 | 12 |
| Evaluation | Thermal Conductivity (W/m · K) | 3.5 | 3.8 | 0.8 | 1.2 |
| | Sheet Appearance | Good | Good | Bad | Bad |

TABLE 2

| | | Second Embodiment of | | | | |
|---|---|---|---|---|---|---|
| | | Silicone Resin | | | Comparative | Comparative |
| | | Composition | Example 3 | Example 4 | Example 3 | Example 4 |
| Silicone | Aluminosiloxane | Triisopropoxy Aluminum | 0.6 | 0.6 | 0 | 0 |
| Resin | Resin | (Parts by Mass) | | | | |
| Composition | | Alkoxysilyl | 5 | 5 | 5 | 5 |
| | | Group-Containing | | | | |
| | | Polymethylsilsesquioxane | | | | |
| | | (Parts by Mass) | | | | |
| | | Alkoxysilyl | 7 | 7 | 7 | 7 |
| | | Group-Containing | | | | |
| | | Polymethylsiloxane | | | | |
| | | Having D · T Unit | | | | |
| | | (Parts by Mass) | | | | |

| | | | | | |
|---|---|---|---|---|---|
| | Colloidal Silica (Parts by Mass) | — | 3 (0.6) | — | 3 (0.6) |
| | Aluminum Nitride (Parts by Mass) | 12 | 12 | 12 | 12 |
| Evaluation | Thermal Conductivity (W/m · K) | 8.7 | 9.5 | 2.5 | 2.7 |
| | Sheet Appearance | Good | Good | Bad | Bad |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A silicone resin composition comprising:
a borosiloxane resin containing a B—O—Si bond and boron nitride.

2. The silicone resin composition according to claim 1, wherein
the borosiloxane resin is prepared from a material component containing a condensation reaction type silicone resin and a boron atom complex, wherein
the content ratio of the boron atom complex is 0.5 to 10 parts by mass with respect to 100 parts by mass of the material component.

3. The silicone resin composition according to claim 2, wherein
the condensation reaction type silicone resin comprising an alkoxysilyl group-containing polysiloxane having basic constituent units of D unit and T unit, and an alkoxysilyl group-containing polysilsesquioxane having a basic constituent unit of T unit.

4. The silicone resin composition according to claim 2, wherein
the boron atom complex is trialkoxy boron.

5. The silicone resin composition according to claim 2, wherein
the borosiloxane resin is obtained by allowing the condensation reaction type silicone resin to react with the boron atom complex in a solvent containing water.

6. The silicone resin composition according to claim 1, wherein
reactive functional group-containing inorganic oxide particles are further contained.

7. The silicone resin composition according to claim 6, wherein
the reactive functional group-containing inorganic oxide particles are colloidal silica.

8. The silicone resin composition according to claim 2, wherein
the borosiloxane resin is obtained by allowing the condensation reaction type silicone resin to react with the boron atom complex in a mixed solvent which is prepared from water and an alcohol and contains the reactive functional group-containing inorganic oxide particles.

9. A method for producing a silicone resin composition comprising the steps of:
preliminarily preparing a material component by blending a condensation reaction type silicone resin with a boron atom complex;
preparing a borosiloxane resin by allowing the material component to be reacted; and
blending the borosiloxane resin with boron nitride.

10. The producing method of the silicone resin composition according to claim 9, wherein in the preliminarily preparing step, the reactive functional group-containing inorganic oxide particles are further blended.

11. A thermal conductive sheet being formed by allowing a silicone resin composition to be applied, wherein
the silicone resin composition comprising a borosiloxane resin containing a B—O—Si bond and
boron nitride.

12. A silicone resin composition comprising:
an aluminosiloxane resin containing an Al—O—Si bond and aluminum nitride.

13. The silicone resin composition according to claim 12, wherein
the aluminosiloxane resin is prepared from a material component containing a condensation reaction type silicone resin and an aluminum atom complex, wherein
the content ratio of the aluminum atom complex is 0.5 to 10 parts by mass with respect to 100 parts by mass of the material component.

14. The silicone resin composition according to claim 13, wherein
the condensation reaction type silicone resin comprising an alkoxysilyl group-containing polysiloxane having basic constituent units of D unit and T unit, and an alkoxysilyl group-containing polysilsesquioxane having a basic constituent unit of T unit.

15. The silicone resin composition according to claim 13, wherein
the aluminum atom complex is trialkoxy aluminum.

16. The silicone resin composition according to claim 13, wherein
the aluminosiloxane resin is obtained by allowing the condensation reaction type silicone resin to react with the aluminum atom complex in a solvent containing water.

17. The silicone resin composition according to claim 12, wherein
reactive functional group-containing inorganic oxide particles are further contained.

18. The silicone resin composition according to claim 17, wherein
the reactive functional group-containing inorganic oxide particles are colloidal silica.

19. The silicone resin composition according to claim 13, wherein
the aluminosiloxane resin is obtained by allowing the condensation reaction type silicone resin to react with the aluminum atom complex in a mixed solvent which is prepared from water and an alcohol and contains the reactive functional group-containing inorganic oxide particles.

20. A method for producing a silicone resin composition comprising the steps of:
preliminarily preparing a material component by blending a condensation reaction type silicone resin with an aluminum atom complex;
preparing an aluminosiloxane resin by allowing the material component to be reacted; and
blending the aluminosiloxane resin with aluminum nitride.

21. The producing method of the silicone resin composition according to claim 20, wherein in the preliminarily preparing step, the reactive functional group-containing inorganic oxide particles are further blended.

22. A thermal conductive sheet being formed by allowing a silicone resin composition to be applied, wherein
the silicone resin composition comprising an aluminosiloxane resin containing an Al—O—Si bond and
aluminum nitride.
